(19) United States
(12) Patent Application Publication
(10) Pub. No.: US 2004/0223078 A1
(43) Pub. Date: Nov. 11, 2004

(54) Support for hand held video camera

(76) Inventor: Adam Zadok, Valley Center, CA (US)

Correspondence Address: FRELING E. BAKER, BROWN MARTIN HALLER & MCCLAIM, 1660 UNION STREET, SAN DIEGO, CA, 92101, US

(21) Appl. No.: 10/434,716

(22) Filed: May 9, 2003

(51) Int. Cl. H04N 3/14; H04N 5/335; H04N 5/225

(52) U.S. Cl. 348/375

(57) ABSTRACT

A support for a camera, comprises a generally L shaped outer frame member having an elongated first arm having, and an elongated second arm, the arms joined the inner ends and extending orthogonal to one another, a pivot mount on the outer end of the first arm, a hand grip on the outer end of the second arm, a elongated inner frame having an upper link having an upper end pivotally mounted at the pivot mount to pivot about a pivot axis orthogonal to the longitudinal axis of the first arm of the outer frame, and a lower link having an upper end pivotally mounted to a lower end of the upper link, a camera mount on the lower end of the lower link adapted to detachably mount a camera, an adjustable thumb screw for selectively moving the camera mount along the lower link of the inner frame for adjusting the combined center of gravity of the camera and the inner frame from a position at the pivot mount to positions displaced from the pivot mount, and a plurality of adjustable position weights mounted at the upper end of the lower link for further adjusting the center of gravity of the camera and the inner.

### REFERENCE TO RELATED APPLICATIONS

The present application is related to Applicant's U.S. Ser. No. 09/923,467, “STABILIZING HOLDER FOR HAND HELD CAMERA” filed Aug. 6, 2001; Ser. No. 09/954,917, entitled “SUPPORT FOR HAND HELD CAMERA” filed Sep. 17, 2001 and Ser. No. 10/131,764, entitled “SUPPORT FOR HAND HELD VIDEO CAMERA” filed Mar. 24, 2002.

### BACKGROUND OF THE INVENTION

The present invention relates generally to the field of operator carried camera supports and pertains particularly to an improved support for hand held cameras.

Camera movement by an operator has an important role in the quality of video taping and moving pictures. Smoothness of movement of the camera on its support and movement of the support by the operator is important for the quality of the film. It is difficult for an individual to hold a hand held movie or video camera reasonably steady and move it smoothly while filming a typical moving target. This is difficult whether the operator is moving or standing still and is particularly difficult when both the target and operator are moving. It is particularly difficult for the average person to get good pictures while walking, running or climbing stairs during filming of a moving target. This difficulty in holding hand held movie and video cameras steady often results in blurry, jerky and unstable pictures.

The motions of a camera for aiming it during shooting of scenes are referred to as pan, tilt and roll. As used in the art and herein, “pan” is a movement of the camera about a vertical axis generally along its vertical support axis. “Tilt” identifies a motion about a horizontal axis that is at a right angle or 90 degrees to the axis of the lens. Finally, “roll” means rotation about an axis parallel to the lens axis.

Some attempts have been made in the past to provide means for steadying a movie or video camera while both the subject and operator are moving. These attempts have been largely directed to large commercial cameras and involve providing expensive systems including a large harness with a spring supported camera support frame. These are unsuitable for the average consumer. The inventor has developed and discloses in co-pending application Ser. No. 09/923,467, filed Aug. 6, 2001; and Ser. No. 09/954,917, filed Sep. 17, 2001 supports that overcome many of the problems of the prior art for personal cameras for the average consumer. However, these devices have some drawbacks to which the present invention is directed. Among the drawback are that the camera tends to swing too easily and at excessive amplitude at times.

There is an evident need for an improved stabilizing support for personal hand held cameras.

### SUMMARY AND OBJECTS OF THE INVENTION

It is the primary object of the present invention to provide an improved stabilizing support for personal hand held movie cameras that overcome the above problems of the prior art.

In accordance with a primary aspect of the present invention, a hand held movie camera comprises a first frame having a hand grip and at least one pivot mount spaced from said hand grip, a second frame pivotally mounted to said first or main frame at said pivot mount, and a camera mount on said second frame member disposed below said pivot mount so that the camera swings free of the main support in at least one direction, and adjustable means for moving the camera support and adjustable weights on the inner frame to enable optimum positioning of the center of gravity of the camera on the support.

### BRIEF DESCRIPTION OF THE DRAWINGS

The above and other objects and advantages of the present invention will become apparent from the following description when read in conjunction with the accompanying drawings wherein:

FIG. 1 is a perspective view of an exemplary preferred embodiment of the present invention shown mounted on a support stand;

FIG. 2 is a rear elevation view of the embodiment of FIG. 1 with a camera shown in phantom;

FIG. 3 is a side elevation view of the embodiment of FIG. 1 with a camera shown in phantom;

FIG. 4 is a side elevation view of the embodiment of FIG. 1 with a camera shown in phantom and the inner frame swung for ward;

FIG. 5 is a rear elevation view of the embodiment of FIG. 1 shown in a fully collapsed position;

FIG. 6 is a side elevation view of the embodiment of FIG. 1 shown in a fully collapsed position;

FIG. 7 is a rear elevation view of the embodiment of FIG. 1 with an enlarged detail view of a portion of the inner frame showing details;

FIG. 8A-8B are enlarged detailed views of a portion of the mounting of the handle to the outer frame showing details; and

FIG. 9A is a view Like FIG. 3 of the inner frame showing one weight deployed and one retracted;

FIG. 9B is a view taken on line 9B-9B of FIG. 9A; and

FIG. 9C is a view taken on line 9C-9C of FIG. 9A

### DETAILED DESCRIPTION OF PREFERRED EMBODIMENTS

The present invention provides an apparatus for solving the aforementioned problems of the prior art by providing a camera support for isolating the camera from certain input motions of the operator. This is carried out in one embodiment by means of a support apparatus for a hand held movie camera which comprises a first or outer frame having a hand grip and at least one pivot mount spaced from the hand grip, a second frame pivotally mounted to the first frame on the pivot mount, and a camera mount on the second frame adjustably position able with its center of gravity below the pivot mount so that the camera swings free of certain movements of the first frame. The camera maintains a substantially level condition regardless of the orientation, within limits, of the base or outer frame.

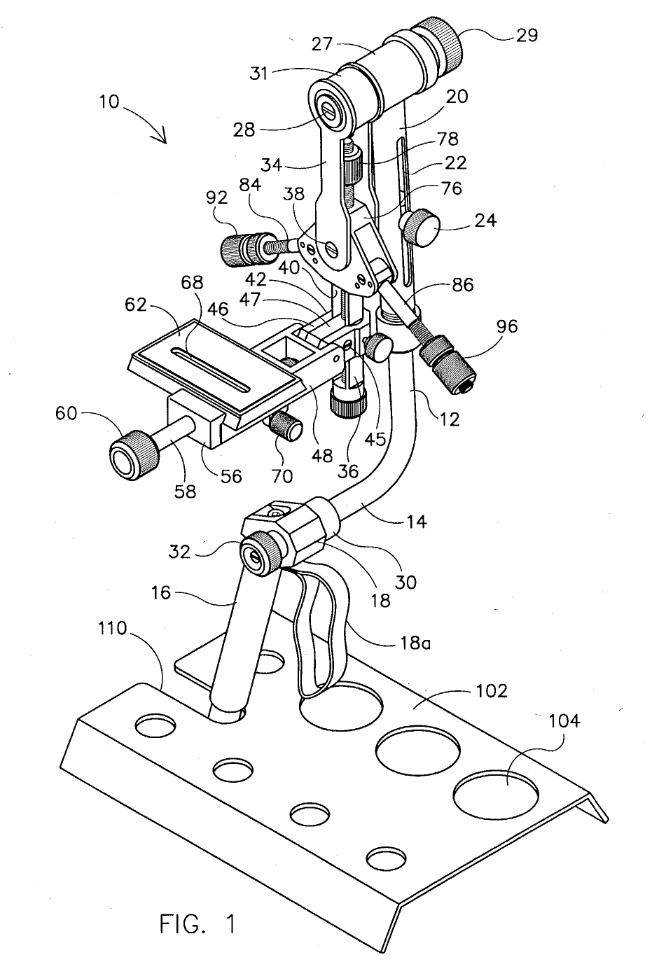

Referring now more specifically to the drawings, and particularly to FIGS. 1-3, one embodiment of a hand held support for a hand held camera is illustrated and designated generally by the numeral 10. In FIG. 1, the camera support is viewed in perspective from the upper left rear of a camera (not shown) and comprises a main first or outer frame having a generally L configuration with an elongated generally vertical primary arm or bar member 12, and a generally horizontal or laterally extending arm 14 extending generally at a right angle to vertical bar 12. The terms vertical and horizontal are only for convenience and refers to positioning or orientation in normal use. The apparatus is shown with the main frame shown in a position for normal operation with the primary arm or bar member 12 extending vertically upward in and the secondary arm 14 extending horizontally. Horizontal or laterally extending arm 14 extends generally horizontally in normal operation and a handgrip 16 is pivotally attached or secured at the outer end thereof and is pivotal between a retracted position and an operative position generally downwardly, preferably at a slight angle forward to the vertical member, as seen in FIG. 3.

Vertical arm 12 is formed or constructed with a telescoping structure to extend and retract to adjust the overall height or length of the frame and position of a housing 27 in which is mounted a pivot shaft 28 for mounting an inner frame to accommodate different size cameras. This construction may take any form such as illustrated with an elongated sleeve or tube 20 having shaft housing 27 at its upper end. Sleeve 20 is telescopically mounted on and receiving the vertical arm 12 with suitable means to lock it in any selected position. In the illustrated embodiment, the sleeve has a slot 22 to accommodate a hand screw with knob 24. The hand screw has a threaded shaft that extends through slot 22 and is mounted in a bore in arm 12. The hand screw is tightened down clamping the portions of the sleeve adjacent the slot into engagement with the surface of arm 12 to lock the sleeve in a selected extended position. This adjusts the position of a pivot shaft 28 at the upper end of arm extension 20 relative to the horizontal arm 14 so that a larger or smaller camera can be accommodated. An adjustable collar 26 is threadably mounted on the lower end of sleeve 20 and is operative to further grip the outer surface of arm 12.

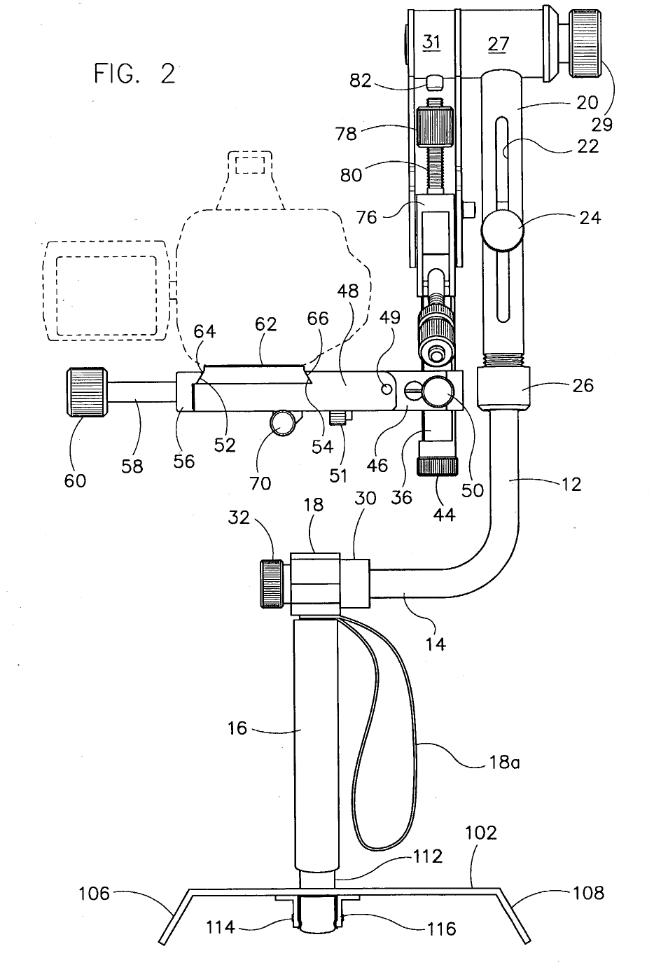

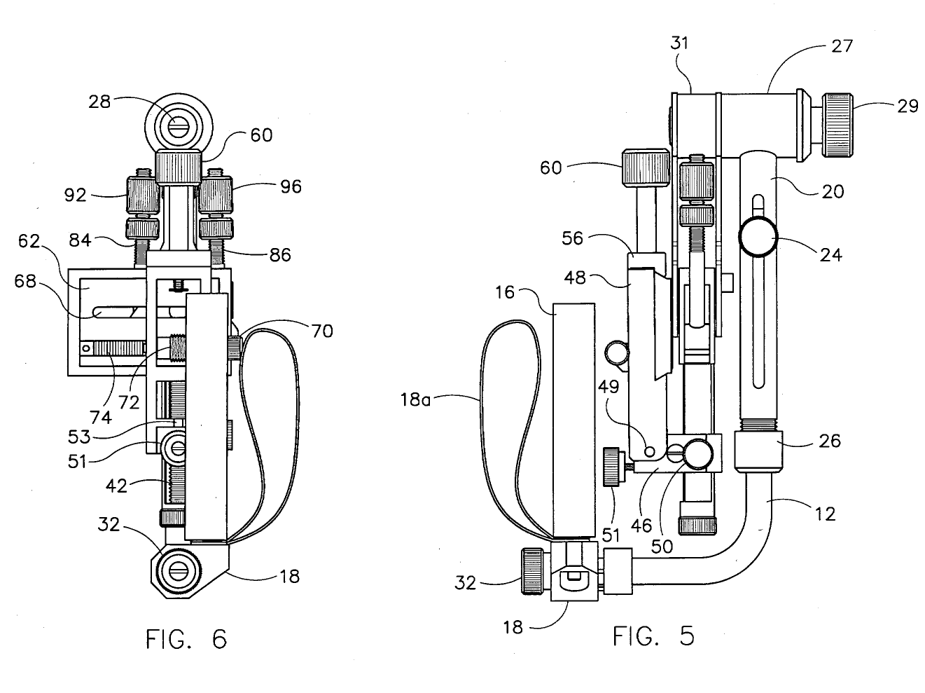

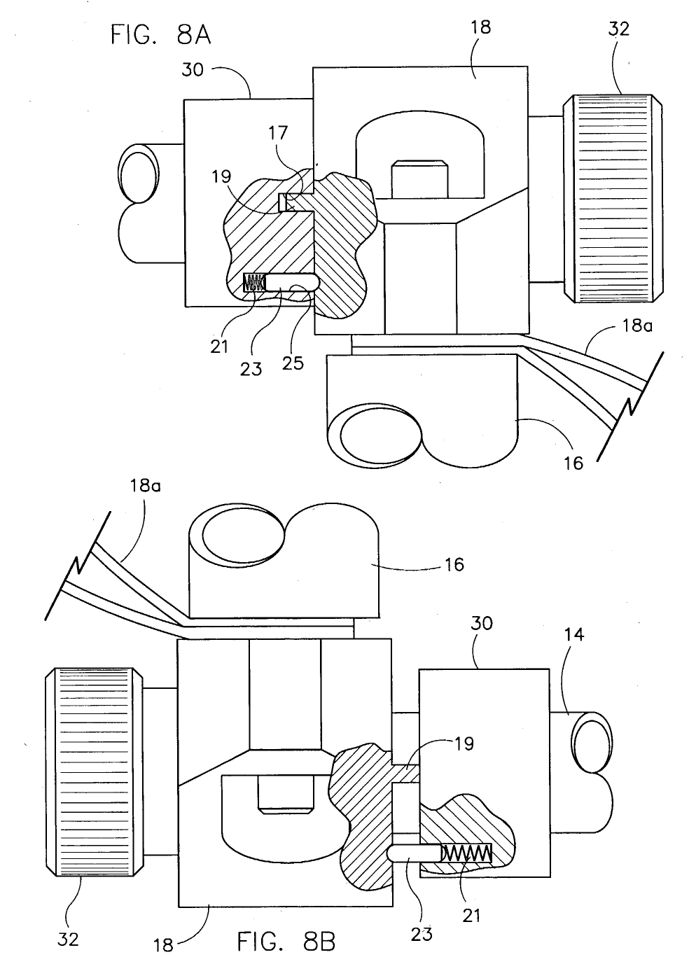

The illustrated hand grip 16 is of a generally conventional design and preferably covered by a foam sleeve for ease of gripping and holding extends downwardly and forwardly as seen in FIG. 3 for normal use. The hand grip is mounted to the horizontal bar by a pivoting or rotating attachment to enable extension of the grip to the operative position (FIGS. 1-3) or retraction to a stowed position (FIGS. 5 and 6). As best seen in FIGS. 8A and 8B a rotating circular collar 18 encircles the horizontal bar between an inner shoulder 30 and a nut 32 defining an outer shoulder. A notch or slot 17 in a side of an inner shoulder or surface of 30 is engaged by a pin 19 on the collar 18 to hold or lock the handle in place bar prevent rotation of grip arm 16. This retains it in the extended operative position. A spring 21 and pin 23 in a bore 25 biases the collar away from the shoulder when nut 32 is moved outward to release the handle and enable it to rotate between an extended position, and a retracted position. The support is designed to be preferably held generally vertically as illustrated in FIG. 1 with the camera above the handgrip in normal operation (FIG. 2). However, it may be held forward of or below the handgrip for lower angle shots. A hand strap 33 is attached to the handle and loops around the hand to help preventing the holder from slipping from the hand.

A second or inner generally L shaped frame comprises an elongated generally vertical main bar or arm formed of an upper arm or link 34 and a lower arm or link 36 pivotally connected together at a pin or bearing assembly 38. The upper end of arm 34 is mounted on shaft 28 on which is mounted or journaled a suitable adjustable tension bearing assembly in bearing housing 31. The bearing assembly is mounted on shaft 28 which is mounted on shaft housing 27 at the upper end of arm 12 of the outer frame. The adjustable tension bearing assembly is of a typical construction with a pair of spaced apart with opposed tapered raceways that enables the tension or freedom of rotation of the bearing to be adjusted to dampen the swing of the arm. A thumb screw or knob 29 is rotatable to adjust pressure on the bearings in housing 31 supported on shaft 28 to adjust the freedom of rotation of arm 34 about the shaft. Thus, the freedom of swinging of arm 34 about its pivot mounting on bearings in housing 31 is adjustable.

The upper arm, in the illustrated embodiment, is formed as a pair of parallel links 34 at opposite ends of bearing housing 31 on shaft 28. Lower arm 36 is formed as a hollow tube or shell having an elongated slot 40 with an inner screw or threaded shaft 42 having a thumb or hand knob 44 for rotation thereof. A bracket 46 is mounted on lower arm or link 36 and threaded insert or segment 47 that engages threaded shaft 42. Bracket 46 supports a camera mounting arm or platform 48 pivotally attached thereto at pin 49. The platform extends between a support position as shown in FIGS. 1-3, and a retracted position as shown in FIGS. 5 and 6. Mounting platform 48 is retained in its downward position by a thumb screw 45 received in a slot 49 (FIGS. 5 and 6) in a web or cross member in lower portion of platform 48. Insert 47 of bracket 46 is engaged by screw 42 to move bracket 46 along the arm 36 to adjust the position of camera mounting platform 48 upward and downward on lower arm 36. A locking thumb screw 50 biases a friction shoe into engagement with a surface of arm 36 and locks bracket 46 in place at selected positions along arm 36.

Video camera mounting platform 48 is configured or formed with a quick mount construction with a releasable dovetail slot formed between opposing sloped walls 52 and 54 to receive a mounting plate 62. Wall 52 is formed on a movable plate or bar 56 mounted on a threaded shaft 58 of a thumb screw having a knob 60 for rotation thereof. A rectangular mounting plate 62 is formed with sloping side walls 64 and 66 for engaging 52 and 54 walls of the dovetail slot. Plate 56 is moveable by rotating thumb screw 58 to open the slot for upward release and removal of mounting plate 62. This provides a quick mount of a camera on the support.

A camera mounts on plate 62 by means of a thumb screw that extends through an elongated slot 68 through the plate and into a bore in the bottom of the camera. Elongated slot 68 enables movement of the camera fore and aft relative to the plate and the positioning of a camera at a substantially balanced position on the mounting platform. In addition, an elongated thumb screw having a knob 70 and a threaded shaft 72 (FIG. 6) is mounted on the platform beneath the plate 62 and engages a rack gear 74 on the bottom of plate 62 for further fine adjustment of a camera position fore and aft relative to pivot axes at 28 and 38. These features enable the selective positioning of a camera center of gravity relative to the pivot axes of the inner frame.

The inner frame is constructed and configured to selectively pivot about either an upper axis at pivot shaft or axis at 28 or about both pivot 28 and pivot axis or shaft 38. This has several advantages as will be appreciated. For example, it enables the holder to accommodate several different sizes of cameras. Smaller cameras would be set to pivot about lower pivot axis 38 as well as swing about axis 28. Larger cameras could be mounted and the inner frame set to swing only about upper axis 28 or about both.

Referring to FIG. 2 a relative small camera is shown, in phantom, mounted on the holder with lower link 36 of the inner frame uncoupled from the upper link. This allows the camera to swing about both pivots. Support arm 48 may be raised or lowered along lower arm or link 36 to position the center of gravity of the swing mass of camera and support relative to pivot axis 38.

Referring to FIG. 3 a relative large camera is shown, in phantom, mounted on the holder and shown in a static or stationary condition. The support is shown mounted on base 102 which enables an operator to adjust the balance of the camera on the support. Support arm 48 may be raised or lowered along lower arm or link 36 to position the center of gravity of the swing mass of camera and support relative to pivot axis 38. If lower arm 36 is coupled to upper arm 34 the center of gravity would be adjusted only relative to upper pivot 28. The center of gravity would be adjusted by a combination of movement of the camera up or down and movement of the weights on their respective arms.

Camera mounting platform 62 and inner frame 34, 36 is equipped with a counter weight assembly comprising a plurality of adjustable weights that are mounted on pivoting arms to pivot between an outward extending use position (FIGS. 1-3) and in inward retracted (FIGS. 5 and 6) position. In the illustrated embodiment, the weight assembly comprises a bracket 76 secured to the upper end of lower arm or link 36 through which pivot pin 38 extends. A first weight or mass 78 is threadably mounted on an upper end of an upwardly extending threaded shaft 80 that forms an extension of the lower link and overlaps a portion of upper link 34. Weight 78 may be rotated to be moved up or down on threaded shaft 80 to shift the center of mass or gravity of the inner frame upward or downward. It also functions in the upper position to engage and couple to pin 82 on upper arm 34 to couple upper and lower arms together to prevent pivoting about lower pivot or axis 38. This secures or restricts the inner frame to pivot only about upper pivot pin 28.

A pair of identical arms 84 and 86 are pivotally attached at pins 88 and 90 to a lower portion of bracket 76 and pivots about the pins between an extended position as in FIGS. 1, 3 and a retracted position as in FIGS. 5 and 6. A weight or mass 92 and lock nut 94 are threadably mounted on an outer end of arm 84. A similar mass 96 and lock nut 98 are mounted on an outer end of arm 86. These masses, when extended, shift the mass on inner frame fore and aft of the center line of the inner frame and aids in balancing the frame about its pivot axes. They also extend the width of the mass relative to the longitudinal axis of the inner frame. This also changes the dynamics of the inner frame and tends to stabilize and reduce the ease of swing of the frame about its pivot axes. A major portion of each arm is threaded to its outer end and receives the respective threaded weight that is moved by rotation along the arm to adjust the mass of the frame and platform outward from a vertical line through upper pivot axes at 28 and 38. This structure and configuration can aid in adjusting the stability of a camera mounted on the platform.

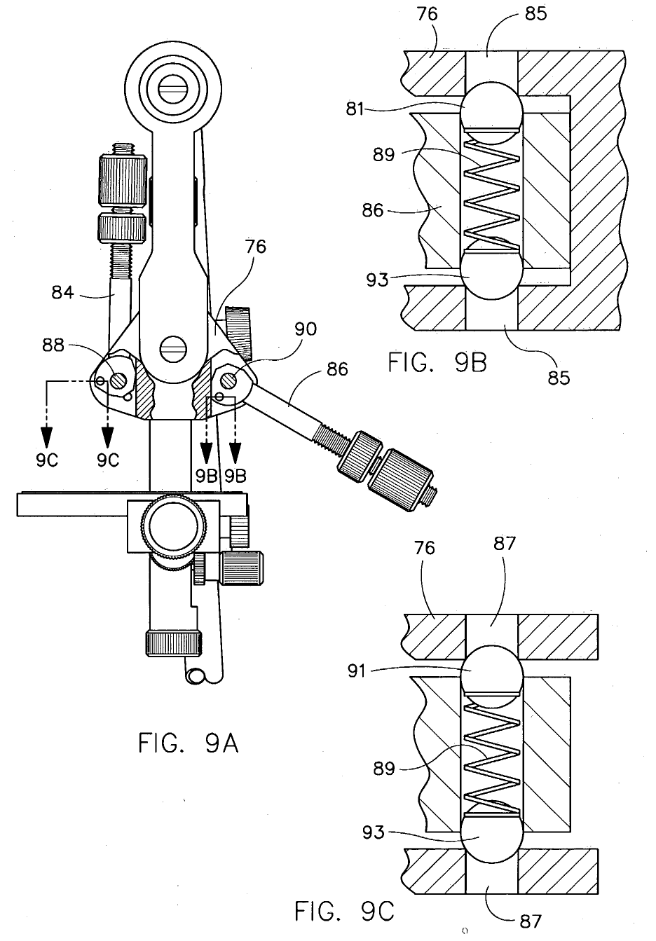

Referring to FIGS. 9A-9C a more detailed view of mounting of arms 84 and 86 are illustrated. Arms 84 and 86 are mounted on pins 88 and 90 and pivot between a retracted position (84) and an extended position (86). The arms are retained in the respective positions by detents having recesses 85 for retracted position and recesses 87 for extended position. Each detent mechanism includes a coil spring 89 biasing balls 91 and 93 into the respective recesses. Other suitable type detent mechanisms many be employed.

The mounting platform is positioned to one side of the handle or hand grip of the frame to balance it relative to the handle. The profile of a Canon Model GL1 is illustrated in place on the platform. Hand grip 16 is preferably selectively mounted at a balance point along horizontal arm 14 to balance the weight of the camera centrally. The hand grip is preferably mounted under the center of gravity and may be directly under the camera or to one side as necessary to affect the balance.

The pivot mount or axis 38 between the upper link 34 and outer lower link 36 of the inner frame is preferably positioned slightly above the center of gravity or mass of the combined camera and inner frame. The pivot arm or distance of the center of gravity from the pivot axis of the lower inner frame is preferably of a value to enable the inner frame to pivot under gravity, but avoid a swinging pendulum effect. This pivot arm can be from as small as one to two millimeters up to between two and three centimeters. The adjustment capability enables a support as described to accommodate several different sizes and models of cameras and enable the camera to swing to and normally maintain a level position during operation.

The illustrated camera support is provided with center of gravity adjusting means in the form of adjustable position mount for the camera as well as weights mounted on threaded extensions to further fine turn the adjustment. These weights allow further adjustment and fine tuning of the position of center of gravity of the inner frame and any camera mounted thereon. As these weights are moved in or out along the arm extensions, they move the center of gravity or mass of the combined camera and inner frame assembly up or down and fore or aft relative the pivot axis.

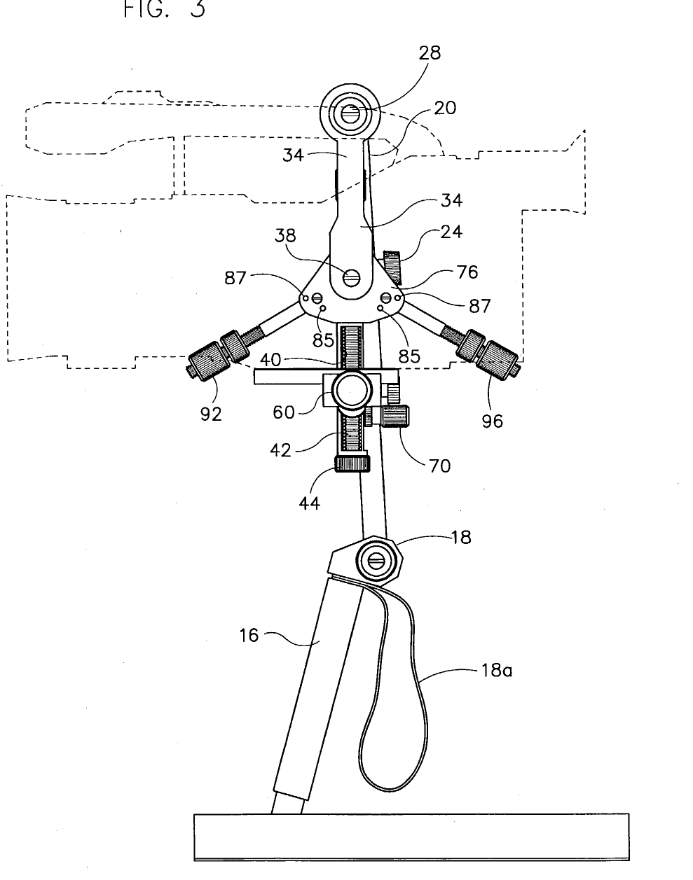

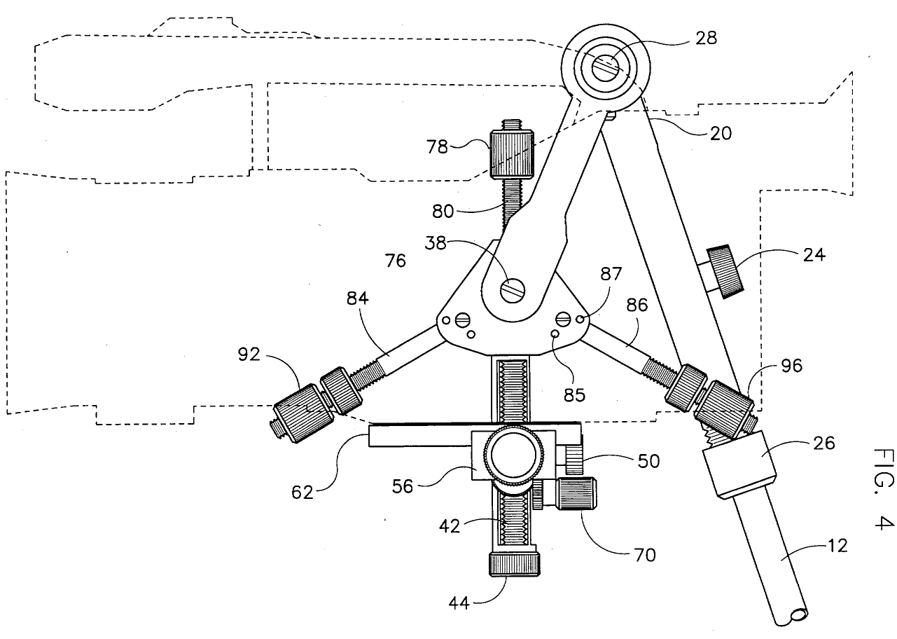

The center of gravity of the camera may be selectively adjusted relative to the pivot axis of the inner frame at 38. The camera will swing with the inner frame and remain level as the main frame is moved or pivoted fore and aft such as shown in FIG. 4. The camera can thus, be moved from or between upper positions and lower positions as necessary. Strap 18a on the hand grip prevents the grip from slipping from the hand when in a lowered or down position. Thus, the camera will swing with the inner frame and remain level as the main frame is moved or pivoted fore and aft between vertical up and down positions.

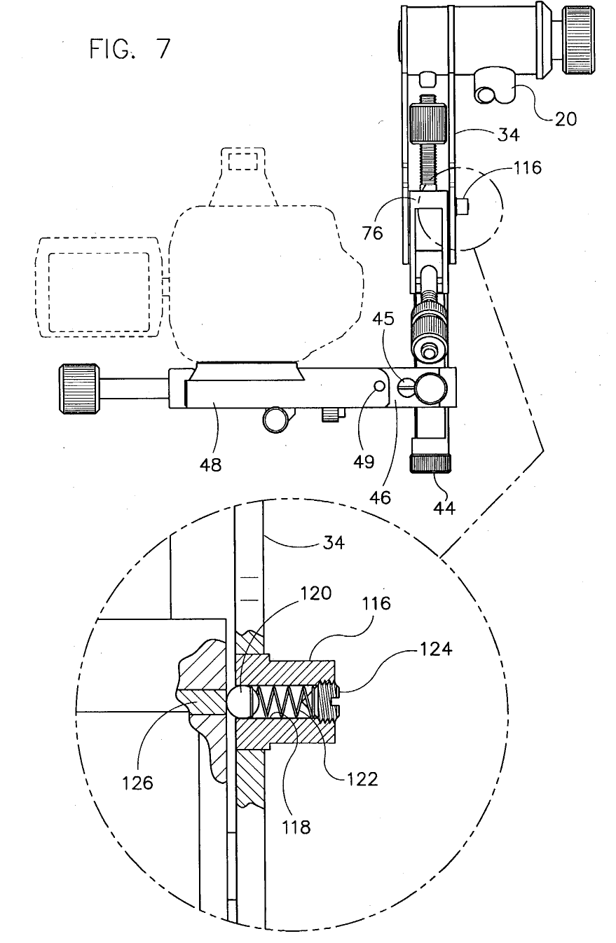

Referring to FIG. 7, the pivot between the upper arm 34 and lower arm 36 of the inner frame preferably includes a pair of spaced apart bearings mounted in a bore in bracket 76 in which is mounted pivot shaft or pin 38. The bearings are within a bore in a friction ring 126 that is engages by a spring biased ball 120 providing a brake or restriction to the ease of pivoting. A cylindrical housing 116 is mounted in arm 34 and has a bore 118 aligned with metal friction ring 126. Ball 120 is mounted at the inner end of bore 118 in engagement with ring 126. A spring 122 is mounted in bore 118 and biases ball 120 into engagement with ring 126. The degree of bias can be adjusted by moving screw 124 in and out and by replacing spring 122 wit a stronger or weaker spring.

The support embodiment, as described above, provides a simple support construction that eliminates one or more component of operator movement input to the camera. This enables smoother handling and operation of video and movie cameras and eliminates many of the motions of the operator that reduces the quality of the pictures. The above described support structures may be sized or slightly modified to accommodate a wide variety and size of cameras. The support structure may also be employed with other base support structures for enhancing the range of manipulation and use. It may also by used in conjunction with other support structures for supporting and handling heavier professional or commercial cameras. The supports may also be used in combination with additional support structures such as vests with an articulated spring arm worn by camera operators available from a number of manufacturers.

A stand may be provided to hold the camera during mounting and adjusting the position of the camera. A stand illustrated in FIGS. 1-3 comprises a generally flat thin rigid rectangular panel 102 having holes 104 for further weight reduction. The panel is formed with down turned side edges 106 and 108 that form feet and space the panel from a support surface. A slot 110 in one end of the panel accommodates the pivoting of a support post 112 from a stowed position beneath the panel to a use position extending upward above the panel. Post 112 is pivotally mounted between a pair of brackets 114 and 116 on the bottom surface of the panel. The post preferably has means such as a pin and slot to prevent rotation of the holder handle 16 relative thereto. The panel may be made of any suitable thin stiff sheet material such as aluminum or any other sheet metal and plastic or paperboard.

In operation, the camera support is normally held in the upright position as shown in FIGS. 1-3, such as mounting on a stand as shown. A camera is mounted on the camera support arm and the camera is adjustably positioned relative to either pivot axis 28 or 38 by first moving the camera support arm up or down on the inner frame. Preferably, the positioning is within about one up to three millimeters of the selected pivot axis. The swing of the camera is tested and further adjusted by selective movement of one or more of the weights to fine tune the camera swing as desired. When the operator tilts the support fore or aft, the camera pivots or tilts about one or more of the pivots and remains essentially level. Adjustment of one or more of the pivots can be used to fine-tune the support to dampen the swing of the camera as desired. The support construction also enables the support to be positioned with the grip in the upper position to allow the camera to be lowered downward below the operator's waist for lower angle shots. The support has the same stabilizing effect of eliminating the longitudinal fore and aft operator input movement in the mode of operation.

In operation, the camera is normally held in the support upright position as shown in FIGS. 1 through 4. When the operator tilts the support fore or aft, the camera pivots about a horizontal axis of the support and remains level. The support construction also enables the support to also be positioned with the grip in the upper position (not shown) to allow the camera to be lowered below the operator's waist for lower angle shots. The support has the same stabilizing effect thereby eliminating the longitudinal axis fore and aft operator input tilt in any mode of operation. While I have illustrated and described my invention by means of particular embodiments, it is to be understood that numerous changes and modifications may be made in the invention without departing from the spirit and scope of the invention, which is to be, limited only by the scope of the appended claims.

I claim:

1. A support for a camera, the support comprising:
a generally L shaped first frame defined by an elongated normally vertical arm and an elongated normally horizontal arm;
a second frame having a first end and a second end and pivotally mounted at one of said first and second ends to an upper end of said elongated vertical arm of said first frame by a pivot mount to pivot about a pivot axis orthogonal to the longitudinal axis of said vertical arm;
a camera mount on the other of said first and second ends of said second frame adapted to detachably mount a camera; and
adjustable means for selectively adjusting a center of the combined mass of a camera mounted on said camera mount and said inner frame from a position substantially at said pivot mount to positions displaced from said pivot mount.

2. A support according to claim 1 wherein said adjustable means comprises means for adjustably positioning said camera mount along said second frame relative to said pivot mount.

3. A support according to claim 1 wherein said adjustable means comprises at least one adjustably positionable weight on said inner frame.

4. A support according to claim 3 wherein said at least one adjustably position able weight is on a co-axial extension of said inner frame on an opposite side of said pivot axis from said camera mount.

5. A support according to claim 3 wherein said adjustably position able weight is moveable with said co-axial extension between a normal use position and a retracted stowed position.

6. A support according to claim 3 wherein said adjustably positionable weight on said inner frame comprises first and second weights, each adjustably mounted on a shaft adjacent said camera mount and normally extending in the direction of movement of said mount about said pivot axis.

7. A support according to claim 6 wherein said adjustably position able weights are moveable with said shaft between a normal use position and a retracted stowed position.

8. A support according to claim 1 further comprising a handgrip mounted on said horizontal arm of said first frame member.

9. A support according to claim 8 wherein said vertical arm of said first frame is adjustable in length to adjust the pivot of said second frame relative to said horizontal arm.

10. A support according to claim 1 wherein:
said second frame comprises an upper link and a lower link pivotally connected together at ends thereof;
said camera mount comprises a bracket mounted on said lower link and moveable along said link and a support arm pivotally mounted on said bracket and pivotal between an extended use position and a retracted stowable position arm; and
a thumb screw mounted on and extending along said lower link engaging and operative to move said bracket along said lower arm for positioning a camera on said mount relative to said pivot.

11. A support according to claim 10 wherein said support arm includes a dovetail groove and a camera mounting plate mounted in and moveable along said groove for adjusting a camera center of gravity relative to said pivot mount.

12. A support according to claim 11 further comprising: an elongated thumb screw mounted on said support arm beneath said dovetail groove and having threads engageable with teeth on a rack gear on a bottom of said mounting plate for selectively positioning said plate on said support arm.

13. A support according to claim 12 wherein said lower link comprises a counterweight mounting bracket at the pivotal connection of said lower link to said upper link and a plurality of threaded arms on said weight mounting bracket and a weight threadably mounted on each arm.

14. A support according to claim 13 wherein one of said threaded arms extends axially of said lower link overlapping said upper link and said weight on said arm moveable to a position to couple said lower link to said upper link.

15. A stabilizer support according to claim 12 wherein:
a pair of said adjustably positionable weight on said weight mounting bracket are each adjustably mounted on a shaft on opposite sides of said weight mounting bracket and normally extending in the direction of movement of said mount about said pivot axis; and
said arms are foldable to a retractable position.

16. A support according to claim 10 further comprising a portable stand for holding said support in a normal use position for camera mounting and adjustment, said stand comprising a thin rectangular rigid panel having side edges turned down for support surface engagement, and a post pivotally mounted in a slot at an end of said panel and pivotal between a retracted position beneath said panel to an upwardly extending use position above said panel.

17. A support for a camera, the support comprising:
a generally L shaped outer frame member defined by an elongated first arm having an outer end and an inner end, and an elongated second arm having an outer end and an inner end, said arms joined said inner ends and extending orthogonal to one another at said inner ends thereof;
a pivot mount on the outer end of said first arm;
a hand grip on the outer end of said second arm;
a elongated inner frame having an upper link having an upper end pivotally mounted at said pivot mount to pivot about a pivot axis orthogonal to the longitudinal axis of said first arm of said outer frame, and a lower link having an upper end and a lower end and pivotally mounted at said upper end to a lower end of said upper link;
a camera mount on the lower end of said lower link adapted to detachably mount a camera;
adjustable means for selectively moving said camera mount along said lower link of said inner frame for adjusting a center of the combined center of gravity of said camera and said inner frame from a position at said pivot mount to positions displaced from said pivot mount; and
a plurality of adjustable position weights mounted at said upper end of said lower link for further adjusting the center of gravity of said camera and said inner frame relative to said pivot mount.

18. A support according to claim 17 wherein said camera mount comprises a support arm pivotally mounted on said bracket and pivotal between an extended use position and a retracted stowable position, a dovetail groove and a camera mounting plate mounted in and moveable along said groove for adjusting a camera center of gravity relative to said pivot mount, and an elongated thumb screw mounted on said support arm beneath said dovetail groove and having threads engageable with teeth on a rack gear on a bottom of said mounting plate for selectively positioning said plate on said support arm.

19. A support according to claim 18 wherein said adjustable weights comprise one arm extending axially of said lower link overlapping said upper link and said weight on said arm moveable to a position to couple said lower link to said upper link, a pair of adjustably positionable weights each adjustably mounted on a shaft on opposite sides of and normally extending in the direction of movement of said inner frame about said pivot axis said arms are foldable to a retractable position.

20. A support according to claim 19 said elongated first arm has a telescoping construction enabling it to be extended and retracted in length.
